(19) United States
(12) Patent Application Publication
(10) Pub. No.: US 2015/0229792 A1
(43) Pub. Date: Aug. 13, 2015

(54) DOCUMENT CAMERA

(71) Applicant: Kenji YOSHIDA, Tokyo (JP)

(72) Inventor: Kenji Yoshida, Tokyo (JP)

(21) Appl. No.: 14/427,531

(22) PCT Filed: Sep. 11, 2013
(86) PCT No.: PCT/JP2013/074599

§ 371 Date: Mar. 11, 2015

(30) Foreign Application Priority Data
Sep. 11, 2012 (JP) 2012-199071

(51) Int. Cl. H04N 1/00; H04N 5/232; H04N 5/33; H04N 5/225

(52) U.S. Cl. CPC H04N 1/00326; H04N 5/2256; H04N 5/23203; H04N 5/23293; H04N 5/33

(57) ABSTRACT

A camera of the invention includes a transmitting unit which transmits code information and/or a control instruction for an information processing device to the information processing device, and the information processing device performs a corresponding process on the basis of code information transmitted from the transmitting means and/or a control instruction to display a predetermined video image on a display device. In a state in which a video image of an object is displayed, when the object is only touched with an optical reading device, a photograph or a moving image corresponding to the touched portion can be instantaneously displayed. For this reason, operation quantity in the information processing device can be reduced.

### TECHNICAL FIELD

The present invention relates to a so-called document camera to display a document and a three-dimensional object on a display means.

### BACKGROUND ART

A document camera can display an object which is being captured on a display or display the object on a screen with a projector. Even though a document is not digitized in advance, since the object can be projected and explained on the spot, the document camera is used in various applications such as school education or a presentation mainly.

### CITATION LIST

PTL 1: Japanese Patent Application Laid-Open No. 6-138543

PTL 2: Japanese Patent Application Laid-Open No. 10-229515

PTL 3: Japanese Patent Application Laid-Open No. 11-252454

### SUMMARY OF INVENTION

A conventional document camera can display an object which is being captured or display the object on a screen with a projector. However, the document camera cannot easily indicate the position of an object to which a lecturer would like to cause a participant to pay attention, or explain the object such that letters or graphics are written on a printed matter.

Furthermore, switching to a photograph, a moving image, and a presentation file (file created with a presentation software such as Presenter, PowerPoint (registered tradename), or Keynote (registered tradename)) which are prepared as data in advance is cumbersome, and searching or cueing of corresponding data cannot be instantaneously performed.

Certainly, when an image of an object and various data are registered in an information processing device in the order of presentations to create a perfect electronic text for lecture in advance, the searching or cueing of data is not impossible. However, in order to create the perfect text, plenty of time and skills are required. In particular, in the field of education, a teacher is busily occupied with works for lectures, rating, being an adviser to a club activity, or the like, and the teacher is difficult to secure time for the operations for creating the perfect text.

### Solution to Problems

In order to solve the above problem of the present invention, it is proposed that a dot technique is introduced into a document camera.

More specifically, a document camera according to the present invention is a document camera including: a camera which captures the object; an illumination device which illuminates the object; an information processing device connected to the camera by a cable or wireless; at least one display device which displays a video image output from the information processing device and is connected to the information processing device by a cable or wireless; and an optical reading device which is connected to the information processing device by a cable or wireless, reads a dot pattern which is formed on a medium surface with a predetermined rule and in which code information is defined, and decodes the dot pattern into the code information, wherein the optical reading device includes a transmitting unit which transmits the code information and/or a control instruction to the information processing device to the information processing device, and the information processing device executes a corresponding process on the basis of the code information transmitted from the transmitting unit and/or the control instruction to display a predetermined video image on the display device.

### Advantageous Effects of Invention

In the present invention, in a state in which a video image of an object is displayed, when the object is only touched with an optical reading device, a photograph, a moving image, or a presentation file corresponding to the touched portion can be instantaneously displayed. For this reason, operation quantity in the information processing device can be reduced. Furthermore, while a printed matter such as a book or a text is displayed, a presenter can mark an important portion and can easily add letters or graphics. For this reason, during a lesson or a presentation, the presenter can make a drawing on the basis of contents of a question or a thing which she/he would like to communicate on the spot to make it possible to share the contents or the thing by participants at a time.

Furthermore, a video image, a photograph, or a moving image of an object and a presentation file which are displayed in a lecture can also be remotely viewed together with voice of a lecturer, and can be recorded on an information processing device or a smart phone by everybody. In this manner, a maximum presentation effect can be expected by minimum preparation.

The object may be a printed matter such as a book, a copy, or an advertising catalogue. As an optical reading device which captures a dot pattern to read a dot code, a pen-type scanner which can be gripped as a pen is desirably used.

### BRIEF DESCRIPTION OF DRAWINGS

FIG. 1 is a diagram showing a most basic configuration of a document camera according to the present invention.

FIG. 2 is a diagram showing contents corresponding to a portion touched with an object.

FIG. 3 is a diagram in which an important portion of the object is marked and letters and graphics are added.

FIG. 4 is a diagram showing a handwriting input application.

FIG. 5 is a diagram showing remote viewing of contents.

FIG. 6 is a diagram showing an embodiment in which an information input device is connected.

FIG. 7 is a diagram showing an embodiment in which a second information processing device is connected.

FIG. 8 is a diagram showing a most basic configuration of a document camera according to the present invention.

FIG. 9 is a diagram (1) showing an embodiment of calibration.

FIG. 10 is a diagram (2) showing an embodiment of calibration.

FIG. 11 is a diagram (3) showing an embodiment of calibration.

FIG. 12 is a diagram (4) showing an embodiment of calibration.

FIG. 13 is a diagram (5) showing an embodiment of calibration.

FIG. 14 is a diagram (6) showing an embodiment of calibration.

FIG. 15 is a diagram (7) showing an embodiment of calibration.

FIG. 16 is a diagram (8) showing an embodiment of calibration.

FIG. 17 is a diagram (9) showing an embodiment of calibration.

FIG. 18 is a diagram (10) showing an embodiment of calibration.

FIG. 19 is a diagram (11) showing an embodiment of calibration.

### DESCRIPTION OF EMBODIMENTS

Embodiments of the present invention will be described below. The embodiments of the present invention are allowed to be executed by being combined to each other.

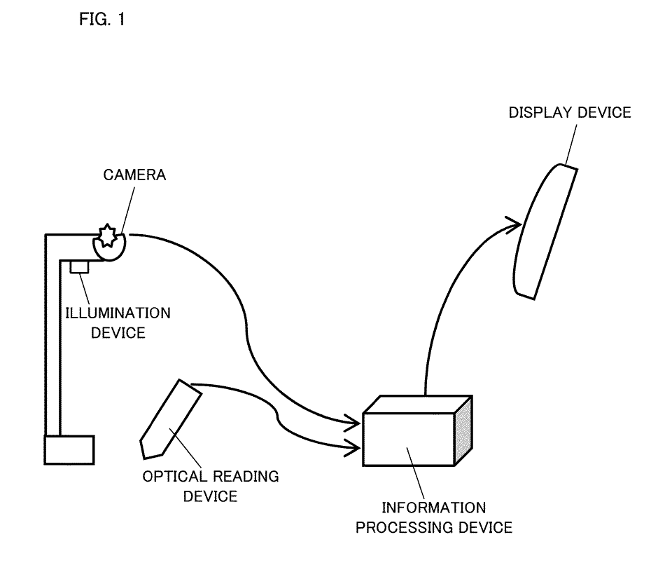

FIG. 1 is a diagram showing a most basic configuration of a document camera according to the present invention. The document camera is a document camera including a camera which captures an object, an illumination device that illuminates the object, an information processing device connected to the camera by a cable or wireless, at least one display device which displays a video image output from the information processing device and is connected to the information processing device by a cable or wireless, and an optical reading device which is connected to the information processing device by a cable or wireless, reads a dot pattern in which code information is defined and which formed on a medium surface with a predetermined rule, and decodes the dot pattern into the code information. The optical reading device includes a transmitting unit which transmits the code information and/or a control instruction to the information processing device to the information processing device. The information processing device executes a corresponding process on the basis of the code information and/or the control instruction transmitted from the transmitting unit to display a predetermined video image on the display device.

The document camera may include a pedestal on which an object is placed.

A dot technique which is unique to the present invention will be described below.

The “dot pattern” in the present invention is obtained by encoding information or a numerical value with an arrangement algorithm of a plurality of dots.

In algorithm for encoding information or a numerical value with a dot pattern, dot patterns particularly disclosed in Japanese Patent No. 3706385, Japanese Patent No. 3858051, Japanese Patent No. 3771252, Japanese Patent No. 4834872, Japanese Patent No. 4899199, and the like can be used. As the standards of typical dot patterns, Grid Onput (registered tradename), an Anoto pattern, and the like are conceived. In addition, since the number of codes is advantageously small when a handwriting input is not mounted, a larger number of dot patterns can be employed.

There are several standards of dot patterns in the market when the present invention is made. However, according to the present invention, in addition to the dot patterns which are present at the present, all dot patterns including dot patterns which will be developed in the future can be used.

As the dot pattern, an invisible dot pattern which can be superposed on a normal design and cannot be seen (or cannot easily seen) is preferably used. However, when the dot pattern is printed by using a so-called stealth ink, a normally visible pattern such as a QR code (registered tradename) may be used.

The standard of a dot pattern is preferably a standard in which coordinate values and a code value can be patterned with one format. The Grid Onput (registered tradename) can pattern coordinate values and a code value with one format.

The largest advantage of introduction of the dot technique is that an operator who uses a document camera can access information which the operator would like to display with one touch.

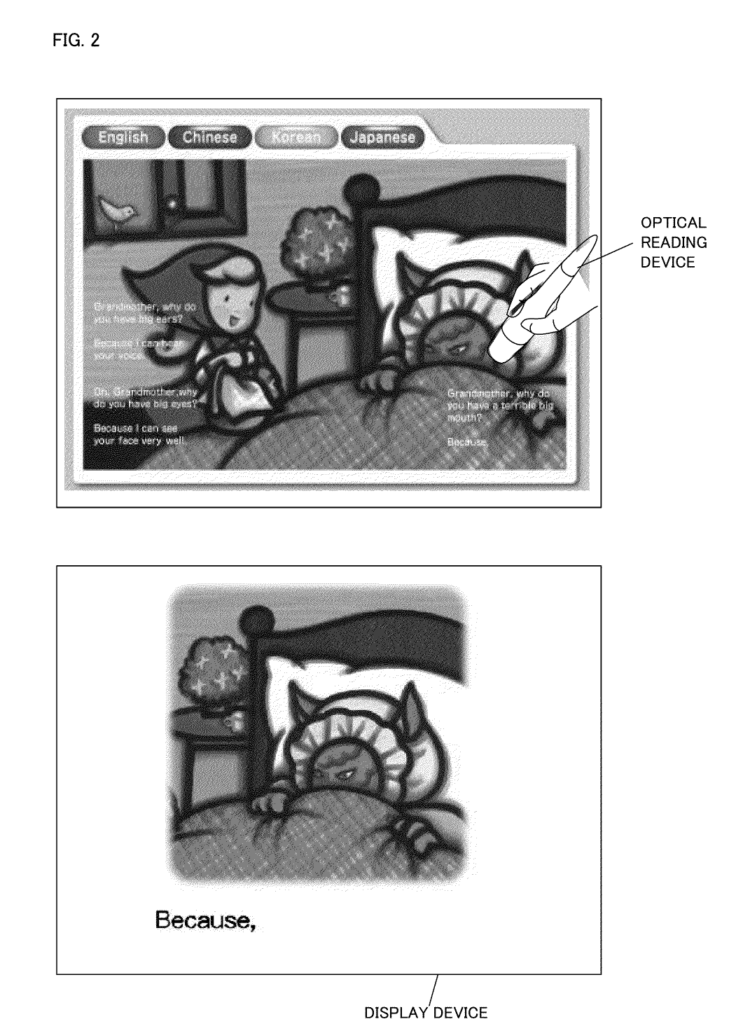

In a certain embodiment, as shown in FIG. 2, in a state in which a video image of an object is displayed, when an object is only touched with the optical reading device, a photograph, a moving image, and a presentation file corresponding to the touched portion can be instantaneously displayed. When the icon of “START” on a printed matter is touched with a scanner, a corresponding dedicated application can be activated. Note that a dot pattern obtained by patterning an activation code for the dedicated application may be printed on the entire area of a printed matter without forming the icon “START”.

As the optical reading device which captures a dot pattern to read a dot code, a pen-type scanner which can be gripped as a pen is preferably used.

A dot pattern on a track is read by using a pen-type scanner (so-called electronic pen or digital pen) which can achieve handwriting input to make it possible to display the track on the display device.

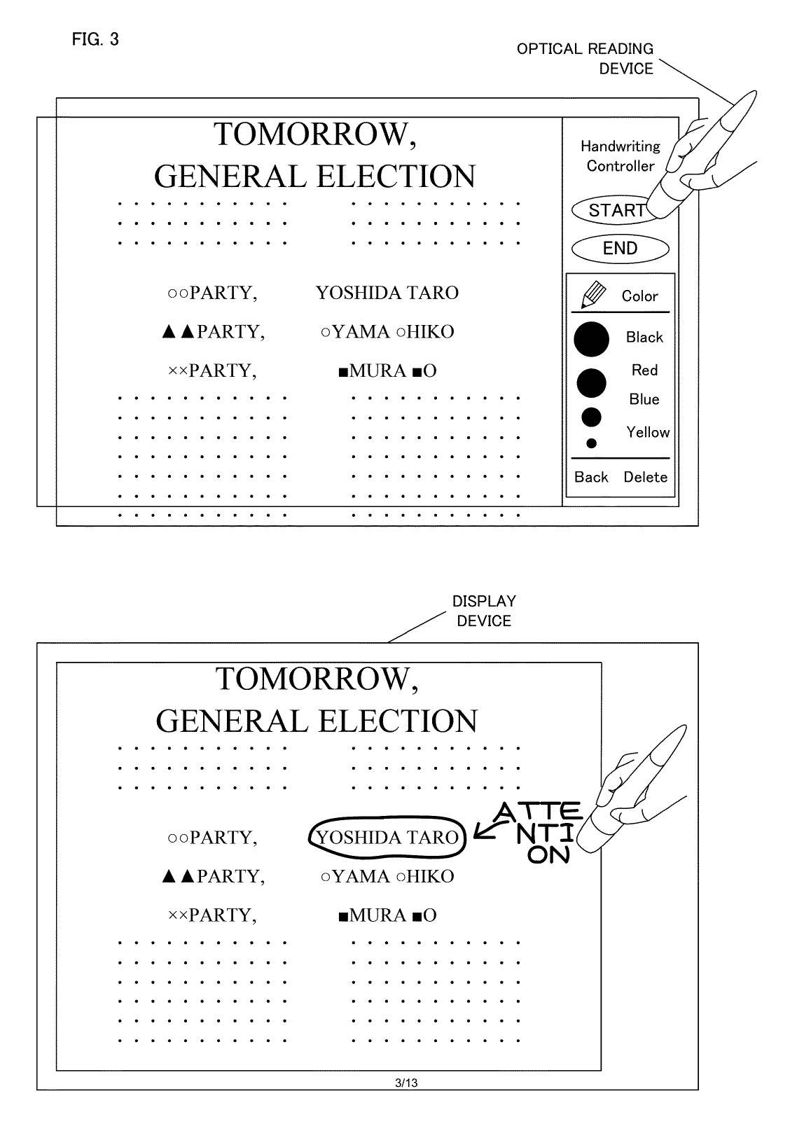

As shown in FIG. 3, while a printed matter such as a book or a text is displayed, an important portion can be easily marked, and letters or graphics can be easily added. When each of icons on a pallet portion on the right side on the printed matter is touched, the color, width, or the like of a line can be changed. On each of the icons, a dot pattern obtained by patterning a code value for instructing the information processing device to change the color or the width of a line is printed. Since the dot pattern printed on paper can instruct the information processing device, this system is called a paper controller.

In another embodiment, as shown in FIG. 4, when an icon “START” on a printed matter is touched with a scanner, a handwriting input application is activated in the information processing device, and the window of the handwriting input application is displayed on the display device.

When a letter is written in a correct stroke order by using a pen-type scanner, fanfare representing a correct answer is reproduced by a loudspeaker (not shown), or an animation representing a correct answer is displayed so as to make it possible to understandably teach students that the stroke order is correct.

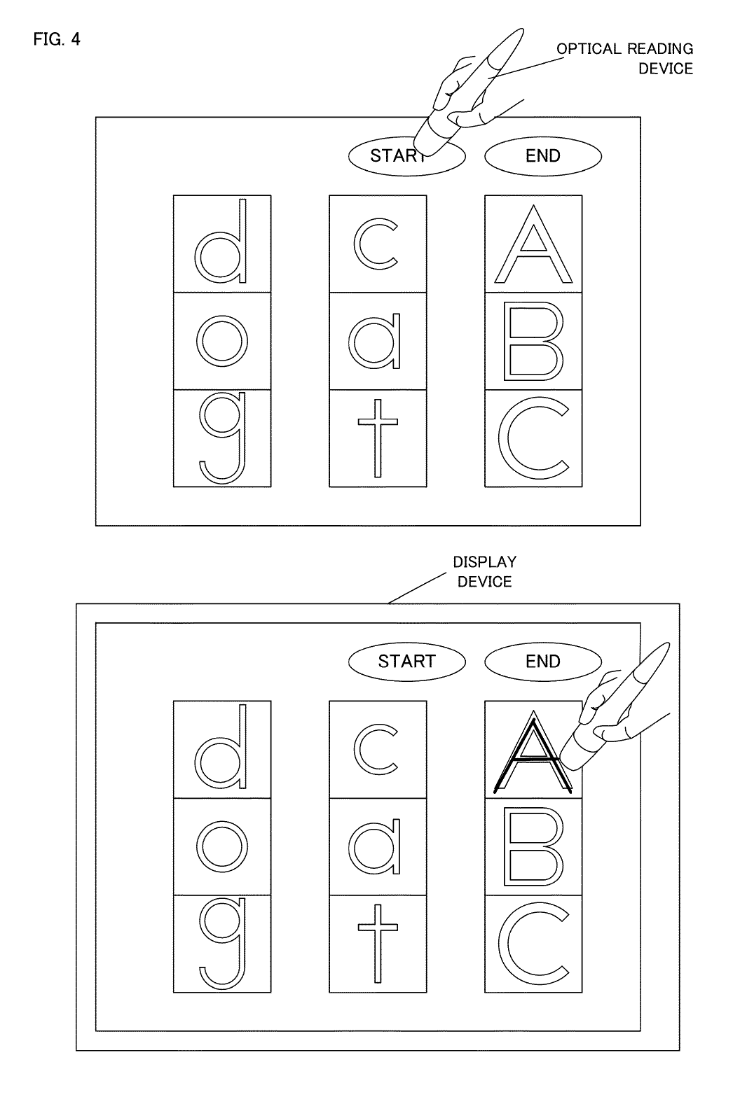

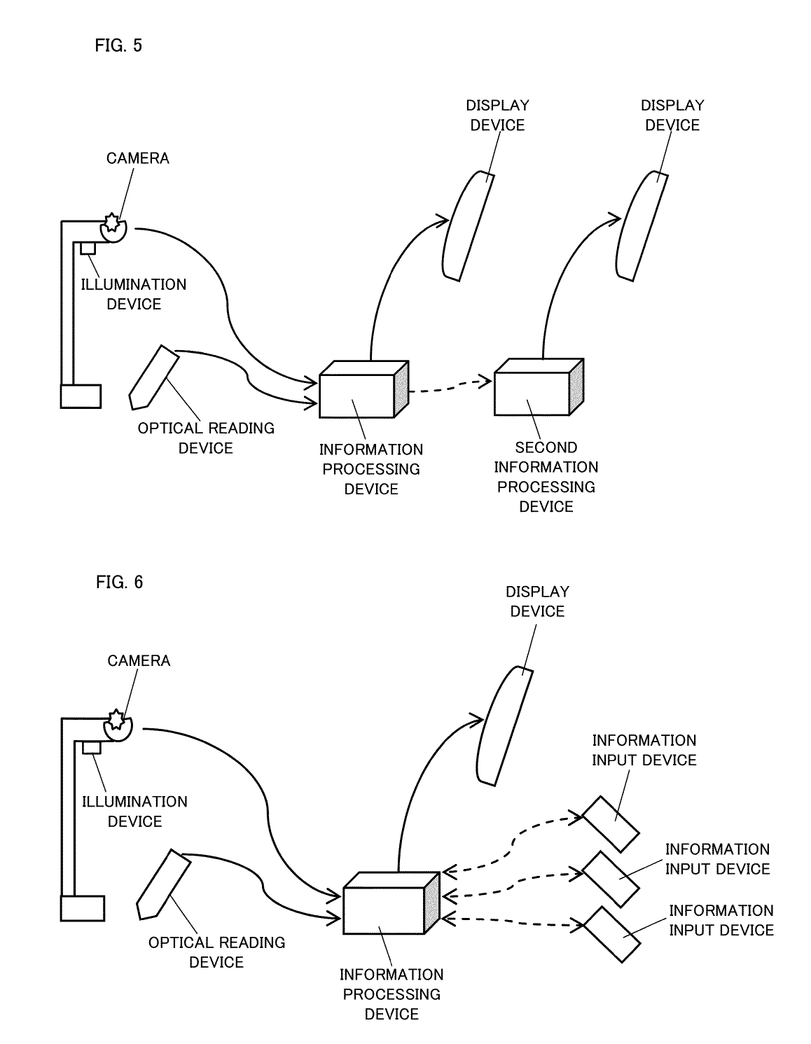

Furthermore, as shown in FIG. 5, the video image, the photograph, and the moving image of an object and a presentation file which are displayed in a lecture can be remotely viewed together with voice of a lecturer and can be recorded on an information processing device or a smart phone by everybody. In this manner, a maximum presentation effect can be expected by minimum preparation.

### <Connection to Information Input Device>

An information input device can be further connected to the information processing device by a cable or wireless as shown in FIG. 6. The information processing device receives a data input from the information input device and processes the data.

Answers to tests or questions made by participants are rated, and results of questionnaires are recorded and displayed to advance a lecture according to the understanding of the participants, so that a more effective lecture can be achieved. Since an ID is added to each of information processing devices, the lecturer can advance the lecture while being aware of relations between the participants and the answers.

The information input device may include a display device. In this manner, a video image or contents displayed in a lecture can be rewinded or enlarged, and the participants can freely repeatedly access the video image or the contents.

The information input device is preferably an optical reading device which reads a dot pattern in which code information is defined and which is formed on a medium surface with a predetermined rule and decodes the dot pattern into the code information.

When a pen-type scanner is used as an input device for a participant, the participant can not only easily input answers to a test or a question but also access the contents in the same text as that of the lecturer. Furthermore, when a participant uses a voice pen, the participant can listen to correct pronunciation in language education or a guide for the text with voice. Each pen-type scanner holds a unique ID. For this reason, data representing a specific participant who holds the pen-type scanner, a specific portion on a medium surface touched with the pen-type scanner, or a specific track traced on the medium surface is transmitted to the information processing device together with time information. These input data are analyzed and edited and can be simultaneously displayed on a display device, and the lecturer can recognize answers and understandings of the participants.

The information input device can be improved in convenience by an intuitive operation achieved by mounting a touch panel on the display device.

When mobile phones, smart phones, portable video-game consoles, and information processing devices which are individually owned by participants are used as the information input devices, the participants can record video images and contents of objects and repeatedly perform learning at their homes.

### <Configuration of Information Processing Device>

A configuration of an information processing device according to the present invention will be described below.

When there is no control instruction from an optical reading device or there is a control instruction which instructs the information processing device to display the video image of an object, the information processing device displays the video image of the object captured with a camera on a display device.

The information processing device displays contents executed by a corresponding process on the basis of a code information and/or a control instruction on the display device. The contents are displayed on the display device together with the video image of the object captured with the camera.

The contents and the video image of the object may be displayed on different windows, respectively.

In a partial region of a window in which one of the contents and the video image of an object is displayed, the other of the contents and the video image of the object may be displayed.

The contents may be displayed to be combined to the video image of the object.

In the information processing device, on the display device, by a corresponding process, on the basis of the code information and/or the control instruction, a mask region in which a dot pattern which is read by the optical reading device and in which the same code information is defined is preferably displayed to be superposed on the video image of the object.

The mask region may be displayed by any one of a method of drawing an outer frame of the mask region in a predetermined opaque or semi-transparent color or a method of marking out the mask region.

The information processing device preferably displays a track obtained by tracing the medium surface on which the dot pattern is formed with the optical reading device on the display device by the corresponding process on the basis of the code information and/or a control instruction such that the track is superposed on the video image of the target.

Here, the track is preferably displayed by drawing the track with a predetermined opaque or semi-transparent color, a predetermined thickness and a predetermined segment.

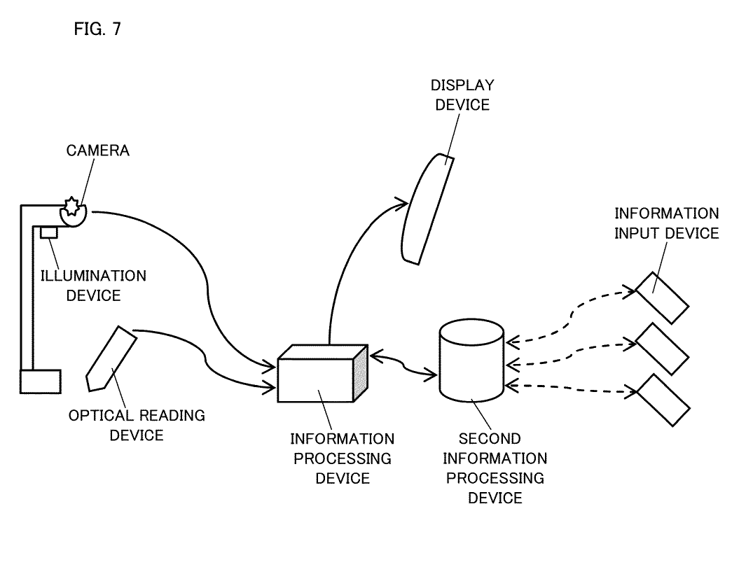

As shown in FIG. 7, a second information processing device including a display device is further connected to the information processing device through the Internet or a communication network to make it possible to transmit a video image and to receive a data input from the second information processing device and to process the data. In this manner, even a participant being at a remote place can rewind or enlarge a video image or contents displayed for lecture like participants attending on the lecture, and the participant can be freely repeatedly access the video image or the contents.

The second information processing device is preferably an optical reading device which reads a dot pattern in which code information is defined and which is formed on a medium surface with a predetermined rule and decodes the dot pattern into the code information. In this manner, even a participant at a remote place, by using a pen-type scanner as an inputting device for a participant, cannot only easily input an answer to a test or a question but also access contents in the same text as that of a lecturer. Furthermore, when a participant uses a voice pen, the participant can listen to correct pronunciation in language education or a guide for the text with voice. Each pen-type scanner holds a unique ID. For this reason, data representing a specific participant who holds the pen-type scanner, a specific portion on a medium surface touched with the pen-type scanner, or a specific track traced on the medium surface is transmitted to the first information processing device together with time information. These input data are analyzed and edited and can be simultaneously displayed on a display device, and the lecturer can recognize answers and understandings of the participants.

When, as the second information processing device, a mobile phone, a smart phone, a portable video-game console, and an information processing device which is individually owned by a participant is used, the participant can record a video image and contents of an object and repeatedly perform learning at her/his home.

The optical reading device and the information processing device which are described above are preferably integrated with each other. The optical reading device and the information processing device are integrated with each other to make it possible to transmit a large amount of data, and the reduction in size of electronic parts further improve convenience. A participant can own a personal optical reading device (information processing device), and a lecture can be started without installing contents in the information processing devices each time a lecture is started, and information management can also be achieved.

### <Optical Reading Device>

A configuration of an optical reading device will be described below.

A control instruction preferably instructs the optical reading device to designate a method of displaying a video image of an object and contents, to switch displays, and to perform display control for stopping, pause, rewinding, forwarding, or repeating when the contents are video images.

The optical reading device includes a device for outputting time information, and a control instruction is preferably based on the time information.

The control instruction is preferably based on code information.

At least one button is arranged on the optical reading device, and the control instruction is preferably based on a button operation.

In the optical reading device, a light-emitting device which points out a region in which a dot pattern is captured or a periphery of the region with visible light.

The optical reading device is preferably a mobile phone, a smart phone, or a mobile video-game console. More specifically, the optical reading device need not be a special device, and may be a device which decodes a dot pattern input as an image with a camera or the like as a dot code with an application recorded in a mobile phone, a smart phone, or a mobile video-game console.

### <Configuration of Dot Pattern Printed Matter>

A configuration of a printed matter on which a dot pattern read with an optical reading device is printed will be described below.

The dot pattern is preferably formed on the surface of an object normally captured with a camera. The object may be a three-dimensional object or a printed matter such as a book, a copy, or an advertising catalogue.

The dot pattern is preferably formed on the surface of the object as a paper controller to be superposed on an icon meaning a control instruction.

The dot pattern is preferably formed on a transparent sheet placed on the object. In this case, a dot pattern is formed on the front surface of the transparent sheet with an ink absorbing infrared rays, an infrared diffuse-reflective layer is formed on the rear surface of the transparent sheet, and the dot pattern may be read with an optical reading device including an LED irradiating infrared rays and a filter transmitting only infrared rays.

The dot pattern may be formed on a transparent case covering the object. In this case, a dot pattern is formed on the front surface of the transparent case with an ink absorbing infrared rays, an infrared diffusion-reflective layer is formed on the rear surface of the transparent case, and the dot pattern may be read with an optical reading device including an LED irradiating infrared rays and a filter transmitting only infrared rays.

The dot pattern is preferably formed with an ink absorbing infrared rays. In this case, the optical reading device includes an LED irradiating infrared rays and a filter which transmits only infrared rays so as to capture a dot pattern formed with an ink absorbing infrared rays.

The dot pattern may be formed with an ink reacting to an ultraviolet ray. In this case, the optical reading device includes an LED irradiating ultraviolet rays so as to capture a dot pattern formed with an ink reacting to ultraviolet rays.

### <Camera, Illumination Device>

Configurations of a camera, an illumination device, and a display device will be described below.

Since the configuration has a structure included in a conventional document camera and a display system using the conventional document camera, an existing document camera and an existing display device can be can be used without being changed. When a pedestal is arranged, a document camera including an existing pedestal can be used.

The camera is connected to an information processing device by any connection means achieved by a cable or a wireless system, and a video image obtained by capturing an object is output to the display device through the information processing device.

Note that the camera is directly connected to the display device by any connection means achieved by a cable or a wireless system, and a video image obtained by capturing an object may be directly output to the display device.

However, an LED which irradiates infrared rays may be used as the illumination device, and an optical reading device which reads a dot pattern may be used as the camera itself. As the camera, a camera which reads visible light and a camera which reads infrared rays may be arranged. Control for switching a timing of reading visible light and a timing of reading infrared rays may be performed in one camera.

### <Display Device>

A configuration of a display device will be described below.

The display device is to display a video image output from the information processing device or the camera. As the display device, any display means can be used.

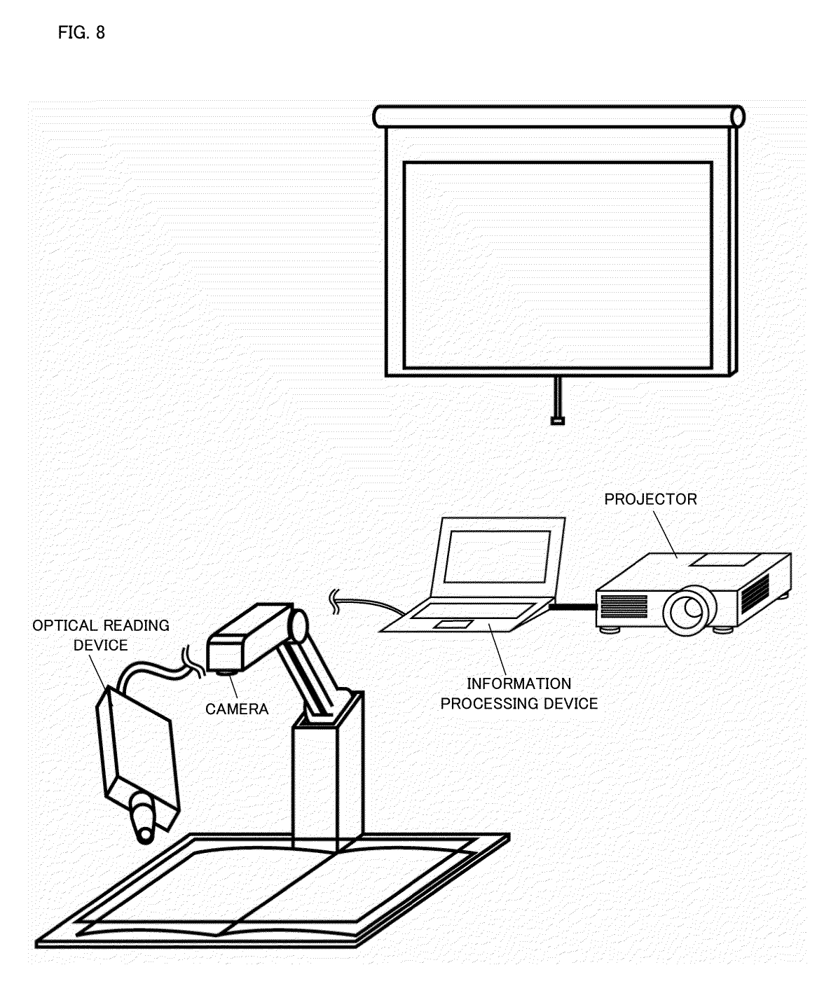

As the display device, a projector as shown in FIG. 8 is optimally used.

The display device may switchably display a video image output from the information processing device and a video image output from the camera or may simultaneously display both the video images.

### <About Calibration>

A calibration method for a document camera will be described below.

In a conventional document camera, an object is arranged under the document camera and directly captured to display an image of the object on a display device. However, when an object is smaller than a capture area, a display screen has a blank space, and the appearance becomes poor. When the object is obliquely placed at a normal position, the object is hard to be seen because the object is obliquely displayed on a display screen. The present invention has proposed a calibration method which can properly display an area which a user would like to display on the display device regardless of the size of an object even though the object is placed by any manner.

### First Embodiment

A first embodiment is a method of arranging a pointer on a camera and performing calibration.

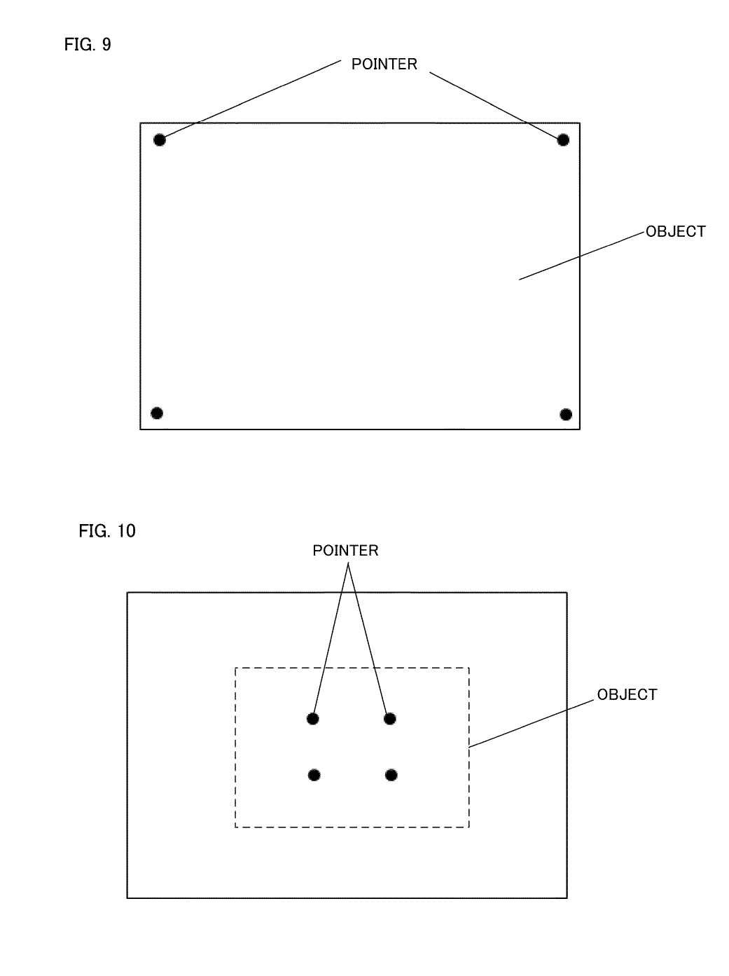

FIG. 9 is a diagram of pointers arranged on a camera. Four pointers such as laser pointers are arranged at the corner portions of the camera. The number of pointers is not limited to four, and two or more pointers need only be arranged. Furthermore, as will be described later, only one pointer may be arranged.

A user arranges an object under the camera. At this time, the pointers irradiate laser beams on the four corners of a printed matter. The user touches the positions on which the pointers irradiate laser beams in a predetermined order. The optical reading device reads dot patterns at the touched positions and transmits data of the dot patterns to the information processing device. The information processing device recognizes dot x-y coordinates (xt, yt) of the touched positions on a coordinate system of the object from the transmitted dot patterns, and performs calibration to properly associate a coordinate system (X-Y coordinate) of the display device with the coordinate system of the object. In this calibration, a coordinate conversion function is used. In order to calculate a conversion coefficient to convert the coordinate system of the object into the coordinate system of the display device, a table for acquiring various parameters corresponding to dot code values (indexes) of the touched positions is used.

In this manner, an entire area of the object is properly arranged on the display device.

FIG. 10 is a diagram for explaining a case in which calibration is executed to an object having a small size.

Pointers used in the present invention are of a movable type. As a matter of course, the pointers may be of a fixed type.

When calibration is performed to an object having a small size, an irradiation area of the pointers is reduced in area. In this manner, as shown in FIG. 10, all the pointers irradiate laser beams within the object.

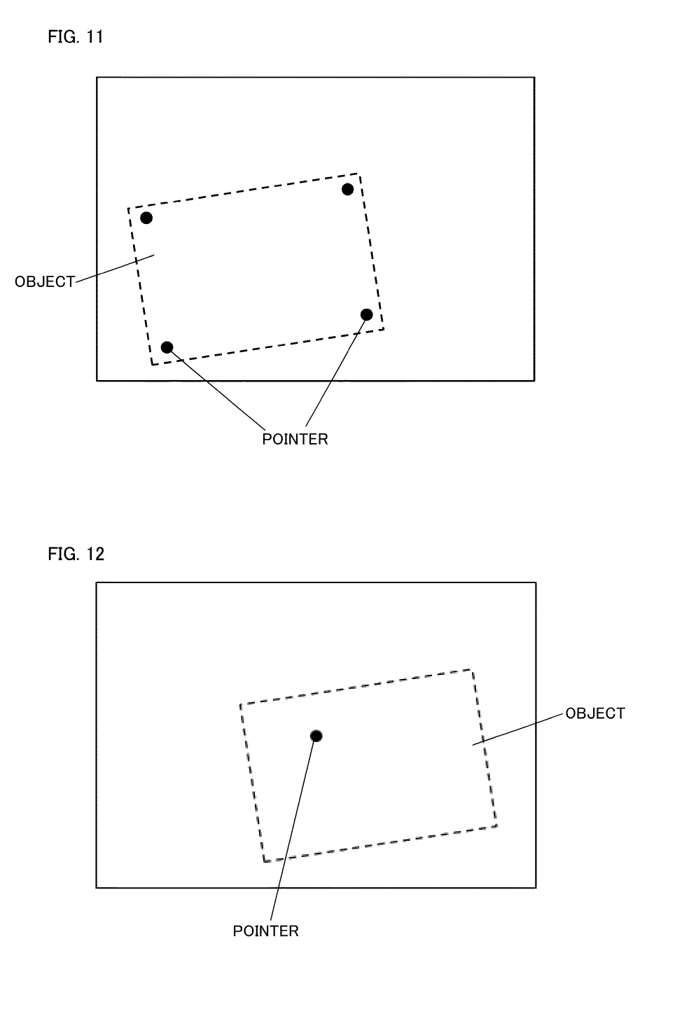

FIG. 11 is a diagram for explaining a case in which calibration is executed to an object which is arbitrarily arranged.

As shown in the drawing, for example, when an object is obliquely arranged on the coordinate system of the display device, the pointers are moved to irradiate laser beams on the four corners of the object.

In this manner, the pointers used in the present invention can be freely moved depending on the size and the orientation of the object. The pointers may be operated with buttons attached to the document camera, or may be operated with various devices of the connected information processing device.

FIG. 12 is a diagram for explaining a case in which one pointer is used.

A coordinate system (coordinate values per unit length) of a dot pattern is stored in a storage means of the information processing device in advance. In this manner, even though only one pointer is used, calibration can be executed.

The pointer irradiates a laser beam on the center of a capture area of the camera. A user touches a position on which the pointer irradiates a laser beam with the optical reading device. A rotating angle of the object is calculated to make it possible to execute calibration.

Furthermore, when the maximum coordinate values of the object are known, according to a calculating formula (will be described later), on the basis of the maximum coordinate values, calibration can also be performed to make it possible to display the region in a predetermined region. The minimum values of the object are defined as (0, 0). As a matter of course, coordinates defined as a start point in advance may be set.

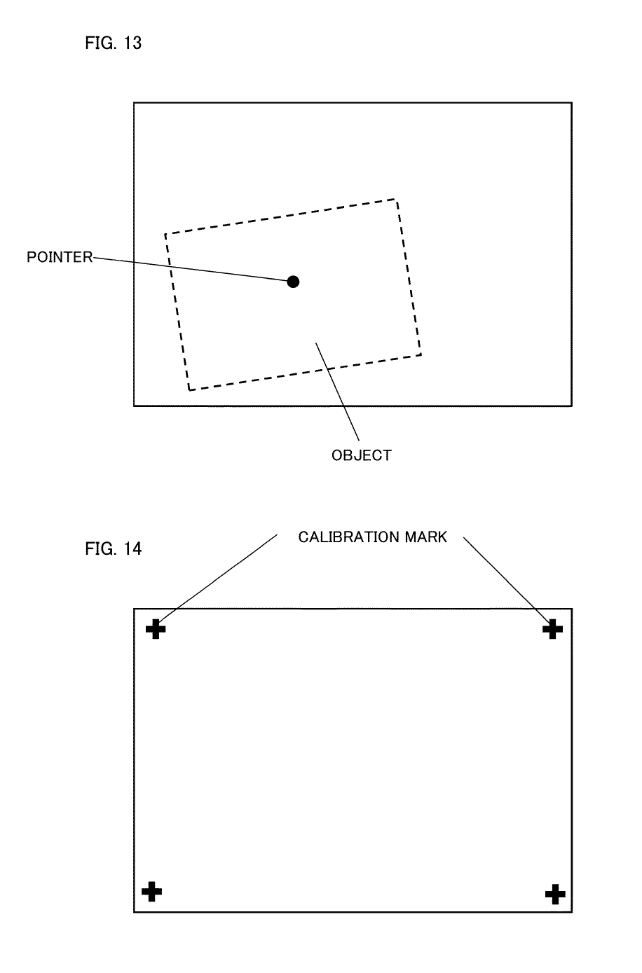

FIG. 13 is a diagram for explaining another example in which one pointer is used.

In FIG. 13, the pointer irradiates a beam on an arbitrary position. In this case, the document camera must know the position of the pointer. More specifically, an irradiated position is stored in a storing means of the information processing device. Furthermore, in the storing means, as in the case in FIG. 12, a coordinate system (coordinate values per unit length and the maximum coordinate values of the object) of a dot pattern is stored in the storing means of the information processing device in advance. In this manner, when a user touches the irradiated position, on the basis of relationships between the touched position, the coordinate system of the dot pattern, and a rotating angle, calibration can be performed.

Furthermore, when the maximum coordinate values of the object are known, on the basis of the maximum coordinate values, calibration can also be performed by a calculating formula (will be described later) so as to make it possible to display the region in the predetermined region. An index is read to make it possible to known the maximum coordinate values.

The above calibration is the first calibration. In the present invention, second calibration can also be performed.

After the entire area of the object is displayed, when a specific portion of the object is explained, a part of the object may be intended to be magnified and displayed. In such a case, the second calibration is performed.

In the second calibration, four corners of a portion to be displayed are touched. At this time, the touched region is cut out, and only the portion is magnified and displayed. In this case, when an aspect ratio of the region is known in advance, a rectangular region can be determined on the basis of at least two positions and displayed. Although not shown, the two positions may be two positions forming one of the vertical and horizontal sides of a rectangle or two corners facing each other.

### Second Embodiment

A second embodiment is a method of performing calibration by using a transparent mark sheet.

As shown in FIG. 14, the transparent mark sheet is a transparent sheet on which calibration marks are printed at four corners. The transparent mark sheet must be placed on a fixed position.

A user covers the transparent sheet on the object. The user touches the calibration marks printed on the transparent sheet with an optical reading device. At this time, the optical reading device reads dot patterns at the touched positions to transmit the dot patterns to an information processing device. The information processing device recognizes dot x-y coordinates (x1, y1) of the touched positions on the coordinate system of the object from the transmitted dot patterns, and calibration to properly associate the coordinate system (X-Y coordinate) of a display device with the coordinate system of the object is performed. In the calibration, a coordinate conversion function is used. In order to calculate a conversion coefficient to convert the coordinate system of the object into the coordinate system of the display device, a table to acquire various parameters corresponding to dot code values (indexes) at the touched positions is used.

The calibration marks are preferably printed with an infrared-transparent ink such that optical reading device can read a dot pattern.

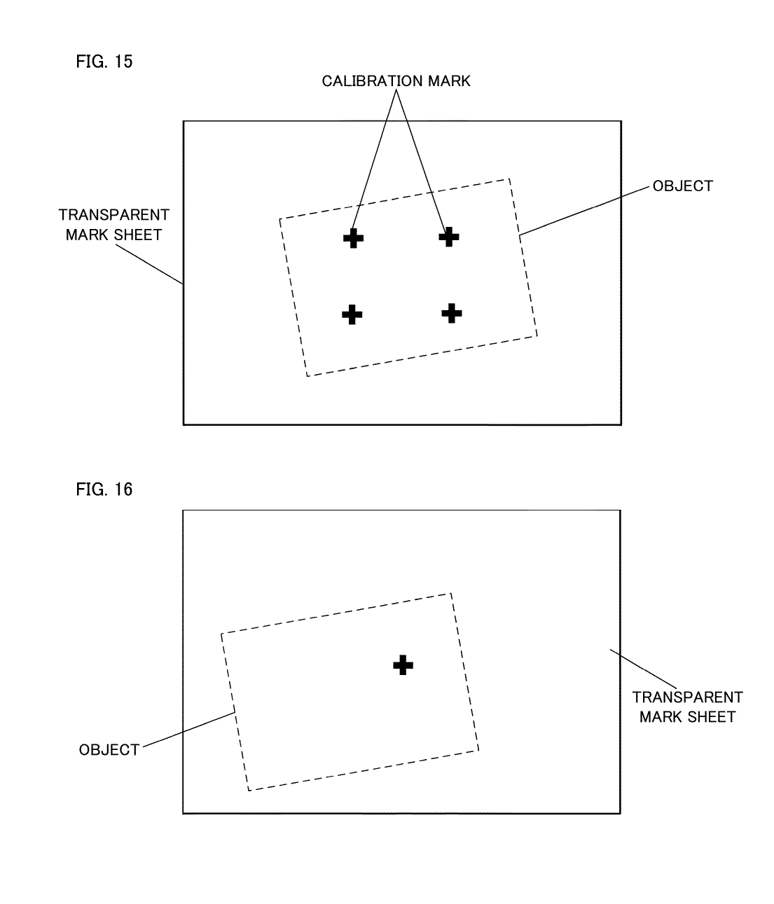

FIG. 15 is a diagram for explaining a case in which calibration is performed to an object having a small size.

In this manner, calibration is performed to an object having a small size, a transparent mark sheet on which a calibration mark is printed near the center is used.

FIG. 16 is a diagram for explaining a case in which one calibration mark is printed.

The calibration method in this case is the same as that in the case in which the pointer is used, a description thereof is not described.

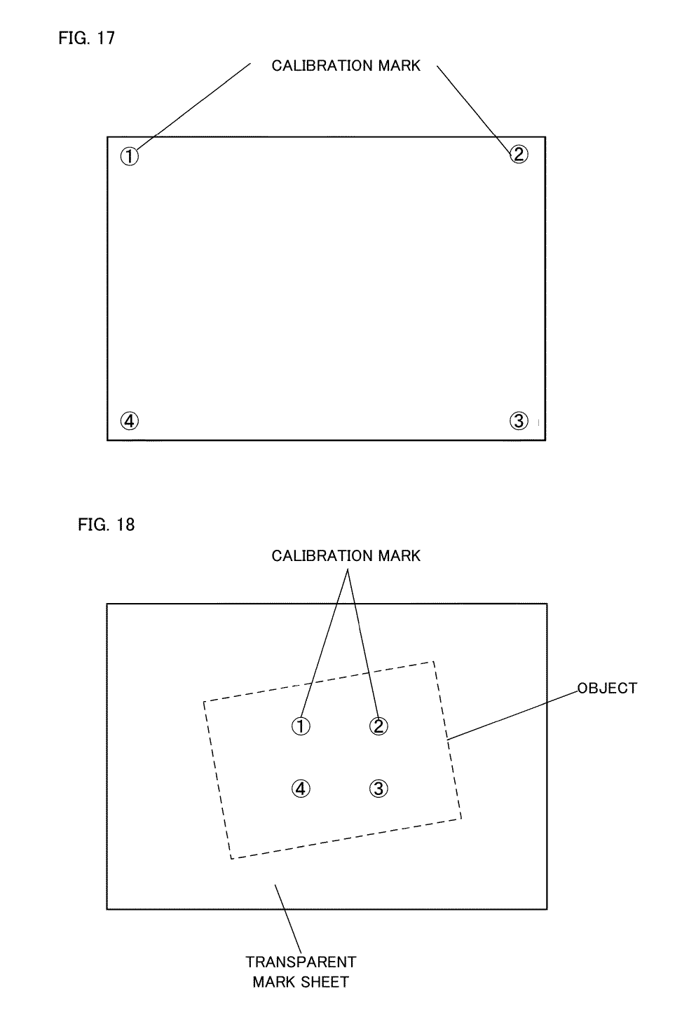

FIGS. 17 and 18 are diagrams for explaining a case in which numbers are given to calibration marks.

When the numbers are given, the calibration marks are touched in the order of the numbers to make it easy for a user to operate the camera.

### Another Embodiment

In addition, in order to place a transparent mark sheet at a fixed position, a mark may be formed on a pedestal used to place an object thereon. A dent may be formed on the pedestal. A user places the object on the pedestal and touches the surfaces of the mark or the dent to make it possible to perform calibration.

The transparent mark sheet may be printed on a grid sheet on which a dot pattern is formed. The details of the grid sheet are described in Japanese Patent No. 4129841.

### <Method of Calculating Coordinate System of Display Device>

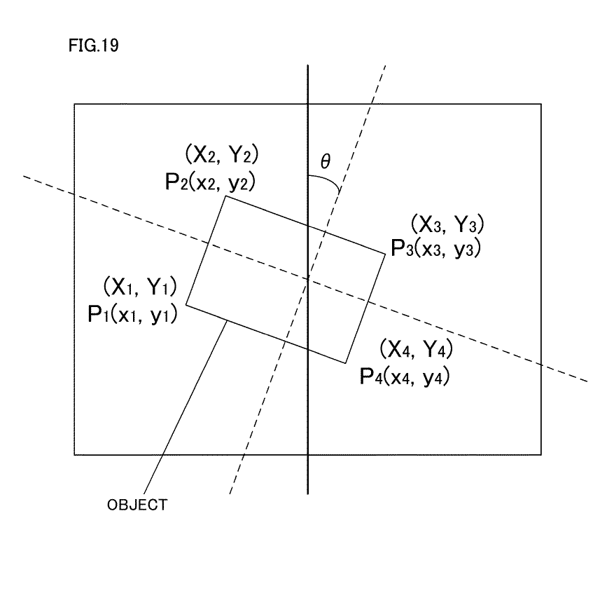

A calculating formula of calibration will be described below with reference to FIG. 19.

Coordinate values of an object on a coordinate system (dot coordinate system) of the object are given by P1 (x1, y1), P2 (x2, y2), P3 (x3, y3) and P4 (x4, y4) ordered from the lower left of the object. The coordinate system of the object is converted into a coordinate system of the display device (X1, Y1), (X2, Y2), (X3, Y3), and (X4, Y4).

When the coordinate values (Xc, Yc) of the center of the display device are given by (Xc, Yc) and an angle between a vertical direction of the display device and the object is given by θ, the coordinate system of the display device is expressed by:

$$\{ \begin{matrix}{X}_{1} \\ {Y}_{1} \\ {X}_{2} \\ {Y}_{2} \\ {X}_{3} \\ {Y}_{3} \\ {X}_{4} \\ {Y}_{4}\end{matrix} \} = \{ \begin{matrix}{X}_{c} \\ {Y}_{c} \\ {X}_{c} \\ {Y}_{c} \\ {X}_{c} \\ {Y}_{c} \\ {X}_{c} \\ {Y}_{c}\end{matrix} \} + \{ \begin{matrix}cos θ sin θ 000000 \\ - sin θ cos θ 000000 \\ 00 cos θ sin θ 0000 \\ 00 - sin θ cos ϑ 0000 \\ 0000 cos θ sin θ 00 \\ 0000 - sin θ cos θ 00 \\ 000000 cos θsin θ \\ 000000 - sin θ cos θ\end{matrix} \} α \{ \begin{matrix}{x}_{t} - {x}_{1} \\ {y}_{t} - {y}_{1} \\ {x}_{t} - {x}_{2} \\ {y}_{t} - {y}_{2} \\ {x}_{t} - {x}_{3} \\ {y}_{t} - {y}_{3} \\ {x}_{t} - {x}_{4} \\ {y}_{t} - {y}_{4}\end{matrix} \} \qquad [ Numerical Expression 1 ]$$

where, when coordinate values Δx, ΔX, Δy, and ΔY per unit length satisfy the following equation:

α=ΔX/Δx=ΔY/Δy

Note that ΔX/Δx may be different from ΔY/Δy.

In this manner, a region extending from (X1, Y1) to (X4, Y4) can be displayed in a predetermined region or an entire region on the display device in a normal state.

### <About Various Operations>

In the document camera according to the present invention, with predetermined operations, a display screen can be rotated, moved, magnified, and reduced.

In the calibration described above, calibration can also be performed after the predetermined operations are performed.

The predetermined operations may be performed by depressing a button arranged on an optical reading device. The predetermined operations may be performed by operating an icon printed on the object or a paper controller arranged independently of the object. Furthermore, the operations may be various operations for the optical reading device by a user. As these operations, grid tilt which is an operation of tilting the optical reading device, grid grind which is an operation of rotating the optical reading device like a joystick, grid turn which is an operation of axially rotating the optical reading device, grid sliding which is an operation of moving the optical reading device, grid scratch which is an operation of repeating small movement of the optical reading device, grid tapping which is an operation of causing the optical reading device to be touched or separated on/from one rotating medium or a plurality of media, and the like are given. Since the details of the operations are disclosed in Japanese Patent Nos. 3830956, 3879106, and 4268659, and the like, a description thereof is not performed here.

### INDUSTRIAL APPLICABILITY

A document camera according to the present invention is made to make reference creations for teaching, presentation, and the like easy. The document camera mainly has applicability in the field of school education (however, other applicabilities are not excluded from the technical scope of the present invention).

1. A document camera: comprising:
a camera which captures the object;
an illumination device which illuminates the object;
an information processing device connected to the camera by a cable or wireless;
at least one display device which displays a video image output from the information processing device and is connected to the information processing device by a cable or wireless; and
an optical reading device which is connected to the information processing device by a cable or wireless, reads a dot pattern which is formed on a medium surface with a predetermined rule and in which code information is defined, and decodes the dot pattern into the code information, wherein
the optical reading device includes a transmitting unit which transmits the code information and/or a control instruction to the information processing device to the information processing device, and
the information processing device executes a corresponding process on the basis of the code information and/or the control instruction to display a predetermined image on the display device.

2. The document camera according to claim 1, wherein the code information is code values, coordinate values, or the code values and the coordinate values.

3. The document camera according to claim 1, wherein the display device is a display connected to a second information processing device connected to the information processing device through the Internet or a communication network.

4. The document camera according to claim 1, wherein the information processing device further includes an information input device connected thereto by a cable or wireless to receive a data input from the information processing device and process the data.

5. The document camera according to claim 4, wherein the information input device includes a display device to display the predetermined video image and/or another video image.

6. The document camera according to claim 4 or 5, wherein the information input device reads a dot pattern which is formed on a medium surface with a predetermined rule and in which code information is defined and decodes the dot information into the code information.

7. The document camera according to claim 5, wherein the display device of the information input device includes a touch panel in which data is input.

8. The document camera according to claim 4, wherein the information input device is a mobile phone, a smart phone, a portable video-game console, or a personal computer.

9. The document camera according to claim 1, wherein the information process device further includes a second information processing device having a display device and connected thereto through the Internet or a communication network, transmits the predetermined video image, and receives a data input from the second information processing device to process the data.

10. The document camera according to claim 9, wherein the second information processing device is an optical reading device which reads a dot pattern which is formed on a medium surface with a predetermined rule and in which code information is defined and decodes the dot pattern into the code information.

11. The document camera according to claim 9, wherein the second information processing device is a mobile phone, a smart phone, a portable video-game console, or a personal computer.

12. The document camera according to claim 1, wherein the optical reading device and the information processing device are integrated with each other.

13. The document camera according to claim 1, wherein the information processing device, when there is no control instruction from the optical reading device or when there is a control instruction for instructing the information processing device to display a video image of the object, displays the video image of the object captured with the camera on the display device.

14. The document camera according to claim 1, wherein the information processing device displays contents executed by a corresponding process on the basis of the code information and/or the control instruction on the display device.

15. The document camera according to claim 14, wherein the contents are displayed on the display device together with the video image of the object captured with the camera.

16. The document camera according to claim 15, wherein the contents and the video image of the object are displayed in different windows, respectively.

17. The document camera according to claim 15, wherein, in a partial region of a window in which one of the contents and the video image of the object is displayed, the other of the contents and the video image of the object is displayed.

18. The document camera according to claim 15, wherein the contents are displayed to be combined to the video image of the object.

19. The document camera according to claim 1, wherein the information processing device, on the display device, by a corresponding process, on the basis of the code information and/or the control instruction,
displays a mask region in which a dot pattern which read by the optical reading device and in which the same code information is defined such that the mask region is superposed on the video image of the object.

20. The document camera according to claim 19, wherein the mask region is displayed by drawing an outer frame of the mask region in a predetermined opaque or semi-transparent color or marking out the mask region.

21. The document camera according to claim 1, wherein the information processing device, on the display device, by a corresponding process, on the basis of the code information and/or the control instruction,
displays a track obtained by tracing a medium surface on which the dot pattern is formed with the optical reading device such that the track is superposed on the video image of the object.

22. The document camera according to claim 19, wherein the track is displayed by drawing the track with a predetermined opaque or semi-transparent color, a predetermined thickness and a predetermined segment.

23. The document camera according to claim 14, wherein the control instruction instructs the optical reading device to designate a method of displaying a video image of an object and contents, to switch displays, and to perform display control for stopping, pause, rewinding, forwarding, or repeating when the contents are video images.

24. The document camera according to claim 1, wherein the optical reading device includes a device for outputting time information, and the control instruction is based on the time information.

25. The document camera according to claim 1, wherein the control instruction is based on the code information.

26. The document camera according to claim 1, wherein at least one button is arranged on the optical reading device, and the control instruction is based on an operation of the button.

27. The document camera according to claim 1, wherein the dot pattern is formed on a surface of the object.

28. The document camera according to claim 1, wherein the dot pattern is formed on a predetermined medium as a paper controller to be superposed on an icon meaning the control instruction.

29. The document camera according to claim 1, wherein the dot pattern is formed on a transparent sheet placed on the object.

30. The document camera according to claim 1, wherein the dot pattern is formed on a transparent case covering the object.

31. The document camera according to claim 1, wherein the dot pattern is formed with an ink absorbing infrared rays.

32. The document camera according to claim 31, wherein the optical reading device includes an LED irradiating infrared rays and a filter transmitting only infrared rays to capture a dot pattern formed with an ink absorbing infrared rays.

33. The document camera according to claim 29, wherein a dot pattern is formed on the front surface of the transparent sheet with an ink absorbing infrared rays, an infrared diffusion-reflective layer is formed on the rear surface of the transparent sheet, and the dot pattern is read with the optical reading device.

34. The document camera according to claim 30, wherein a dot pattern is formed on the front surface of the transparent case with an ink absorbing infrared rays, an infrared diffusion-reflective layer is formed on the rear surface of the transparent case, and the dot pattern is read with the optical reading device.

35. The document camera according to claim 27, wherein the dot pattern is formed with an ink reacting to ultraviolet rays.

36. The document camera according to claim 35, wherein the optical reading device includes an LED which irradiates infrared rays and captures the dot pattern formed with the ink reacting to ultraviolet rays.

37. The document camera according to claim 1, wherein the optical reading device includes a light-emitting device which points out a region in which the dot pattern is captured or a periphery of the region with visible light.

38. The document camera according to claim 31, wherein
the illumination device further includes an LED irradiating infrared rays, and
the optical reading device includes a filter transmitting only infrared rays to capture a dot pattern formed with an ink absorbing infrared rays.

39. The document camera according to claim 1, wherein the optical reading device is a mobile phone, a smart phone, or a portable video-game console.

40. The document camera according to claim 1, wherein
the camera is directly connected to the display device by a cable or wireless, and
the display device displays a video image output from the information processing device and/or a video image output from the camera.
